(19) United States
(12) Patent Application Publication
(10) Pub. No.: US 2024/0104664 A1
(43) Pub. Date: Mar. 28, 2024

(54) MONITORING SYSTEM FOR DISTRIBUTED RULES BASED HIERARCHICAL AUDITING AND MANAGEMENT OF HEALTH CARE SERVICES

(71) Applicant: Change Healthcare Holdings, LLC, Nashville, TN (US)

(72) Inventors: Sheila Miller, Nashville, TN (US); Michael Bradigan, Nashville, TN (US); Jeffrey Wright, Nashville, TN (US); Michael Marcus, Nashville, TN (US); Andrew Laurer, Nashville, TN (US); Lourn Bun, Nashville, TN (US); Mona Schuessler, Nashville, TN (US)

(21) Appl. No.: 17/945,639

(22) Filed: Sep. 15, 2022

(51) Int. Cl. G06Q 40/08

(52) U.S. Cl. CPC G06Q 40/08

(57) ABSTRACT

In an embodiment, a method is provided. The method includes receiving claim edit information including a plurality of claim edits made to a plurality of claims at a first time interval, where the plurality of claim edits are made using a rule; receiving claim information representing the status of the plurality of claims at a second time interval; and determining a persistence value based on the plurality of claims at a second time interval and the plurality of claim edits made at a first time interval.

### FIELD

The present disclosure relates generally to health care systems and services and, more particularly, management of claims for health care services processed by payor entities.

### BACKGROUND

Health care services are delivered to patients through health care providers, e.g., one or more medical practitioners. Payment for these services is usually made by one or more payors, which may include the patient and another entity, such as an insurance company. Both private companies and public organizations, such as the Medicare and Medicaid programs run by the federal government, and public employee programs run by the federal government or states, may act as payors. Payors may be penalized for improperly denying payment for health care service claims, but may also be harmed financially for approving payment for claims that cannot be justified. To improve the accuracy in determining which claims to pay, which claims to pay in part, and which claims to deny, payors may use an auditing system that provides recommendations on the payment process. The auditing system may be designed with various packages of rules that can be applied to the claims to make the recommendations on payment. A payor, however, may not have licensed all of the various rules because they are not frequently used or because of the costs associated with licensing certain rules packages. In addition, a payor may only upgrade the auditing system rules on a fixed schedule, which may be infrequent. This may delay a payor gaining access to new rules that have been developed based on regulatory standards and best practices.

### SUMMARY

In an embodiment, a method is provided. The method includes receiving claim edit information including a plurality of claim edits made to a plurality of claims at a first time interval, where the plurality of claim edits are made using a rule; receiving claim information representing the status of the plurality of claims at a second time interval; and determining a persistence value based on the plurality of claims at a second time interval and the plurality of claim edits made at a first time interval.

In some embodiments of the present disclosure, the persistence value includes information about the value of the claims at the first time interval and the second time interval.

In some embodiments of the present disclosure, the persistence value includes information about a number of edits to the claims at the first time interval and at the second time interval.

In some embodiments of the present disclosure, the first time interval is one month.

In some embodiments of the present disclosure, the method includes displaying a user interface comprising a visualization of the persistence value.

In some embodiments of the present disclosure, the visualization of the persistence value includes a survival curve.

In some embodiments of the present disclosure, the plurality of claim edits are made using a primary editing system and a secondary editing system.

In an embodiment, a system is provided. The system includes a memory device having instructions stored thereon that, when executed by one or more processors, cause the one or more processors to perform operations including: receiving claim information comprising a claim and an amount paid on the claim; receiving primary claim editing information from a primary claim editing system comprising a primary edit made to the claim, where the primary edit includes a decision to deny a first portion of the claim; receiving secondary claim editing information from a secondary claim editing system comprising a secondary edit made to the claim, where the secondary edit includes a decision to deny a second portion of the claim; and determining, based on the claim information, the primary claim editing information, and the secondary claim editing information, a persistence value for the claim.

In some embodiments of the present disclosure, the persistence value includes information about the value of the claim.

In some embodiments of the present disclosure, the claim information includes information about whether the primary and secondary edits were denied.

In some embodiments of the present disclosure, the persistence value includes information about whether the primary edit and the secondary edit caused a savings on the final amount paid on the claim.

In some embodiments of the present disclosure, the method includes displaying a user interface comprising a visualization of the persistence value.

In some embodiments of the present disclosure, the visualization of the persistence value includes a survival curve.

In some embodiments of the present disclosure, the primary edits or secondary edits include a plurality of rules, and where the visualization of the persistence value includes a survival curve for each of the rules.

In an embodiment, a non-transitory computer readable media having instructions stored thereon is provided, that, when executed by one or more processors, cause the one or more process to perform operations including: receiving claim information comprising a claim and an amount paid on the claim; receiving primary claim editing information from a primary claim editing system comprising a primary edit made to the claim, where the primary edit includes a decision to deny a first portion of the claim; receiving secondary claim editing information from a secondary claim editing system comprising a secondary edit made to the claim, where the secondary edit includes a decision to deny a second portion of the claim; and determining, based on the claim information, the primary claim editing information, and the secondary claim editing information, a persistence value for the claim.

In some embodiments of the present disclosure, the persistence value includes information about the value of the claim.

In some embodiments of the present disclosure, the claim information includes information about whether the primary and secondary edits were denied.

In some embodiments of the present disclosure, the persistence value includes information about whether the primary edit and the secondary edit caused a savings on the final amount paid on the claim.

In some embodiments of the present disclosure, the instructions further include displaying a user interface comprising a visualization of the persistence value.

In some embodiments of the present disclosure, the visualization of the persistence value includes a survival curve.

Other systems, methods, features and/or advantages will become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is a block diagram of a hierarchical auditing system for health care service claims in accordance with some embodiments of the present disclosure;

FIG. 2 is a block diagram that illustrates a communication network including a hierarchical auditing system, which includes a primary auditing system, a secondary auditing system, and a remote connection system, for generating processing recommendations for health care service claims in accordance with some embodiments of the present disclosure;

FIG. 3 is a block diagram that illustrates a system for processing claims to determine persistence information and present data via a dashboard interface;

FIG. 4A illustrates an example method for determining a persistence value of a claim edit;

FIG. 4B illustrates an example method for determining a persistence value of a claim edit;

FIG. 5 illustrates an exemplary computer for use with the disclosed embodiments;

FIG. 6 illustrates an example user interface including a persistence report;

FIG. 7 illustrates an example user interface including a persistence timeline;

FIG. 8 illustrates an example user interface including savings information; and

FIG. 9 illustrates an example user interface including a persistence timeline with multiple rules.

### DETAILED DESCRIPTION

The present disclosure relates to systems and methods related to determining the persistence of an edit made to a claim. In particular, systems and methods are described for determining the persistence of edits made to a claim where a system includes a primary and secondary editing module.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the figures and their previous and following description.

As used herein, the term “provider” may mean any person or entity involved in providing health care services to a patient.

Some embodiments of the present disclosure are described with reference to a payor determining whether to make payment for a claim for services or products. In the context of a health care environment, a payor may be, for example, an entity that provides health or medical insurance, such as private insurance companies and government insurance agencies, both at the federal and state levels (e.g., Medicare, Medicaid, public employee insurance agencies, and the like). Health care providers may submit claims for medical services rendered, products prescribed (e.g., medications, medical devices, etc.), administrative fees, and/or other fees or expenses to a payor for payment. Upon receiving a claim, the payor may then determine whether to pay the claim in whole, in part, or deny the claim. A claim may include both header and line information. The header may be information that applies to the entire claim, e.g., patient details (name, date of birth, address, etc.). The line information may identify the various services, products, fees, expenses, and/or other items for which payment is sought and may be referred to as line item(s). Thus, a payor may evaluate each line in the claim to determine whether to pay the invoiced amount in full, in part, or to deny payment for that line. A payor, such as an insurance company operating in the health care field, may make use of a claims auditing system to assist them in determining whether to pay and how much to pay for the various lines listed in claims submitted for payment. As described above, payors may be penalized for improperly denying payment of a claim. But a payor may suffer economically if payment is made for fraudulent claims or claims for which reimbursement has not been authorized or contracted for. Some embodiments of the present disclosure stem from a realization that the claims auditing system used by a payor may only contain a subset of all the rules that may be available for evaluating claims for payment. For example, the rules may be packaged together in groups, which are sometimes referred to as knowledge packs, and a payor may only license or purchase a portion of the rules. In some circumstances, the payor may wish to have access to more rules, but schedules updates to the claim auditing system on a fixed schedule, which may result in an extended time period before new rules can be introduced into the system. According to some embodiments of present disclosure, a secondary auditing system may be provided that includes additional rules for evaluating claims for payment that are not available to the payor by way of the primary auditing system. The secondary auditing system may be provided, for example, remotely through a cloud service. A remote connection system may provide an interface between the primary auditing system and the secondary auditing system. The remote connection system may act as a filter at the claim level for determining whether to forward a claim including the line items therein to a secondary auditing system. The remote connection system may, or may not, forward a claim to the secondary auditing system based on one or more claim level fields that may be indicative of whether a secondary auditing system may provide value.

For example, a claim level field may be defined that provides an identification for the claims processing system used by a payor. If the claims processing system is not configured to accept a recommendation from a secondary auditing system, then the remote connection system need not forward the claim to the secondary auditing system. Similarly, a field may be defined indicating whether a patient is self-insured or non-self-insured. The remote connection system may not forward claims associated with patients who are self-insured. In some embodiments, when the primary auditing system makes a determination to assign a do not pay status to one or more line items in a claim, then the secondary auditing system will not be tasked with making a further recommendation. Nevertheless, line items in a claim that have been assigned a do not pay status by the primary auditing system may be useful to the secondary auditing system in evaluating line items in the same claim or other claims for payment.

Thus, some embodiments of the present disclosure provide a tagging mechanism in which a tag can be associated with a line item in a claim. The tag can assume multiple states and can be used to provide more nuance to the general rule that denied line items are not forwarded to the secondary auditing system for evaluation. A tag may be viewed as an instruction or a mechanism for conveying information that may be used by a rules engine running on the secondary auditing system for evaluating the line item with the tag or for using the tagged line item to evaluate another line item in the same claim or another claim. For example, if the primary auditing system recommends denying payment for a line item of a claim with high certainty, then this line item may be useful to the secondary auditing system in evaluating line items in the present claim or other claims even though the secondary auditing system would not be tasked with making a payment recommendation on that tagged line item because of the primary auditing system recommendation of denying payment. Conversely, if the primary system recommends denying payment for a line item of a claim with less certainty, including those instances where the primary auditing system recommends a person perform a manual review of the line item, then the tag state may be set to prohibit or limit the secondary auditing system's use of the line item in evaluating other claims and other line items due to the uncertainty surrounding present line item. Thus, some embodiments of the present disclosure provide for sending claims to a secondary auditing system in whole or not at all based on claim level field information. By sending or not sending entire claims, the primary system need not split apart claims by line with some lines being sent to a secondary auditing system and others filtered and not sent to the secondary auditing system. This reduces the processing power needed to divide the claims into individual lines and re-assemble the claims once a secondary auditing system has completed making recommendations on the lines that were sent to it. Other embodiments, however, may allow for the division of claims into lines with decisions being made at the claim line level of which lines to send to a secondary auditing system for evaluation.

The remote connection system may also be used to merge the recommendations between the primary auditing system and the secondary auditing system including resolving any conflicts that may occur due to the primary auditing system having access to more or different historical claim data than may be available to the secondary auditing system. A primary or secondary auditing system may access claim history from an Operational Data Store (ODS) database and/or from their claims processing system.

Moreover, a primary auditing system may pass claim history information on to a secondary auditing system. A payor may control how much or how little claim history is passed to a secondary auditing system. As a result, a primary auditing system and a secondary auditing system may have different history information. In some embodiments, the payor may elect to only communicate historical claim information associated with paid claims because a paid claim is typically a final decision making it the most accurate. Although described herein in the context of a primary auditing system and a secondary auditing system for evaluating claims for payment, the system architecture may be viewed as a hierarchical auditing system including a primary auditing system and one or more secondary auditing system(s). Multiple secondary auditing systems may be connected in series in a daisy-chain manner with a remote connection system supporting the addition of each new secondary auditing system to the chain. Rules may be developed including the use of tags to determine which line items are forwarded to each successive secondary auditing system. According to some embodiments described herein, the rules used for evaluating claims for payment may be distributed over a hierarchy of auditing systems beginning with a primary auditing system and one or more secondary auditing systems. The rules applied to claim line items via a secondary auditing system may result in the denial of payment or a reduction in payment amount for one or more line items that otherwise would have been approved by the primary auditing system thereby providing savings to the payor. The payor may subscribe or license the rules provided in a secondary auditing system on a contingency basis where the payor is charged a percentage of the savings that are obtained through use of the secondary auditing system. Because the secondary auditing system may be provided as a service, such as a cloud service, for example, a payor may gain access to new rules on an expedited basis without having to wait to update the rules in the primary auditing system.

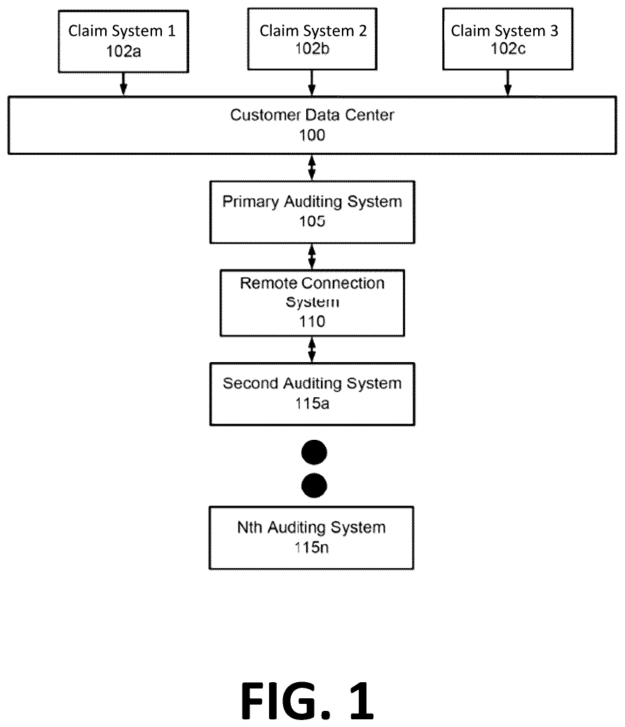

FIG. 1 is a block diagram of a hierarchical auditing system for health care service claims in accordance with some embodiments of the present disclosure. Referring to FIG. 1, a payor, such as an insurance entity operating in the health care field, may have a customer data center 100 through which claims are received, evaluated and processed for payment.

The claims may be received by the customer data center 100 through one or more claim systems 102a, 102b, and 102c, such as claim system 1 102a, claim system 2 102b, and claim system 3, 102c. Each of these claim systems 102a, 102b, and 102c may be used to receive and coordinate payment for claims generated by providers (e.g., health care or medical service providers). The claim systems 102a, 102b, and 102c may use different formats, but the claims may each include header information and line information or line items as described herein. The payor may use the customer data center 100 to organize the claims and evaluate whether to pay the claims in whole, in part, or to deny the claims. The customer data center 100 may be representative of an entity for handling or processing claims. In the example embodiments provided herein, the claim systems 102a, 102b, and 102c may be integrated into the primary auditing system 105 and the customer data center 100 may provide a user interface. Each claim system 102a, 102b, and 102c may be independent of the other and have its own primary and secondary auditing system as well as its own user interface. The payor may use a primary auditing system 105, which contains rules for evaluating the claims for payment (in whole or part) or non-payment (claim denial or rejection). The payor may also make use of one or more secondary auditing systems, which are shown as a second auditing system 115a through an Nth auditing system 115n in FIG. 1. These secondary auditing systems 115a, . . . , 115n may be linked serially through one or more remote connection systems 110. The secondary auditing systems 115a, . . . , 115n may be accessed, for example, through the cloud and may provide access to rules for evaluating claims for payment that are not available to the payor by way of the primary auditing system 105. The remote connection system 110 may be configured to serve as a proxy for forwarding claims to a secondary auditing system 115a, . . . , 115n for evaluation for payment. In this regard, the remote connection system 110 may provide a tagging capability in which a line item may have a tag associated therewith that can be configured in one or more states to provide instructions, which can then be processed by rules running on one or more of the secondary auditing systems 115a, . . . , 115n in the hierarchy to evaluate the tagged line for payment or for use in support in evaluating other lines in the same claim and/or other claims. The remote connection system 110 may also be configured to merge the payment recommendation between the primary auditing system 105 and one or more of the secondary auditing systems 115a, . . . , 115n.

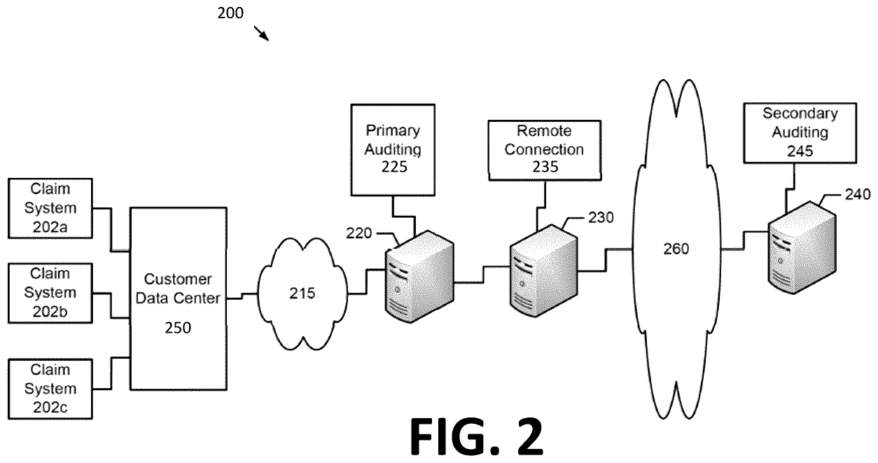

Referring to FIG. 2, a communication network 200 including a hierarchical auditing system, which includes a primary auditing system, a secondary auditing system, and a remote connection system, for generating processing (e.g., payment) recommendations for health care service claims comprises a customer (e.g., payor) data center 250 that is coupled to one or more claim systems 202a, 202b, and 202c, and also coupled to a primary auditing system server 220 via a network 215. Each of the claim systems 202a, 202b, and 202c may be used to receive and coordinate payment for claims generated by providers (e.g., health care or medical service providers). The claim systems 202a, 202b, and 202c may use different formats, but the claims may each include header information and line information or line items as described above. The customer data center 250 may be a data center including one or more servers associated with a payor, such as an insurance entity operating in the health care field. The primary auditing system server 220 may be configured to assist the customer data center 250 in evaluating whether to pay, pay in part, or deny payment for line items in claims that are processed for payment in the customer data center 250. The primary auditing server 220 may include a primary auditing module 225 that includes rules for evaluating and making payment recommendations for the line items in the claims. The primary auditing module 225 may also include history information on past claims received and processed, which can be used in evaluating new claims for payment. For example, if a patient is limited to a certain number of physical therapy sessions, then historical claims may be consulted to determine if a patient has reached a limit for which payment is authorized.

As described herein, a payor may not subscribe or license all of the rules available for evaluating claims for payment. In addition, a payor may only schedule updates for rules running on the primary auditing system server 220 infrequently, which may deprive the payor to access of more recent rules that have been developed for evaluating line items in claims for payment.

To allow the payor to access additional rules for evaluating claim line items for payment in an expedited fashion, a remote connection system server 230 may be used to provide access to a secondary auditing system server 240. The secondary auditing system server 240 includes a secondary auditing module 245, which includes additional rules not available via the primary auditing module 225 for evaluating claim line items for payment, payment in part, or non-payment. The secondary auditing module 245 may also include some history information for claims and/or line items that have been previously evaluated and processed. The remote connection system server 230 includes a remote connection module 235 and may be configured to serve as a proxy for filtering and forwarding claims to a secondary auditing system 115a, . . . , 115n for evaluation for payment. In some embodiments, the remote connection system server 230 may provide a tagging capability to provide instructions that may be processed using the rules running on the secondary auditing system server 240. The various states associated with a tag may be interpreted by the rules running on the secondary auditing system 240 to evaluate the present tagged line for payment and/or use the present tagged line to evaluate another line for payment in the same claim and/or different claim. For example, a line item of a claim that has been recommended for non-payment by the primary auditing system server 220 may be processed by secondary auditing system server 240 based on the state of a tag associated therewith. If the certainty associated with the non-payment recommendation is high, then a tag may be associated with the line item and configured in a state that allows the secondary auditing system server 240 to use the information in the line item as support in evaluating one or more other line items in the same claim or other claims for payment. Conversely, if the non-payment recommendation generated by the primary auditing module 225 is made with less certainty, including circumstances where a manual review is recommended, then the tag state may be set to prohibit or limit the secondary auditing module's 245 use of the line item in evaluating other claims and other line items due to the uncertainty associated with the primary auditing module's 225 recommendation. The remote connection system server 240 may also be configured to merge the payment recommendation between the primary auditing system server 220 the secondary auditing system server 240.

The customer data center 250 of FIG. 2 and the customer data center 100 of FIG. 1 may be configured with a user interface that allows a customer, e.g., a payor, to view the recommendations generated by the primary auditing system server 220 and the secondary auditing system server 240 for claims and the individual line items contained therein. The primary auditing module 225 may have references to all rules used in the secondary auditing module 245. In general, an auditing system higher in the hierarchy may have references to all rules used by auditing systems used lower in the hierarchy. In some embodiments, the user interface may allow a payor to review which specific rules have been triggered in the primary auditing system server 220 and/or the secondary auditing system server 245 in making a recommendation. This may allow a payor to directly see the benefit of individual rules on each auditing system in the hierarchy in generating potential savings when processing claims for payment.

A network 260 may be used to couple the primary auditing system server 220 and remote connection server 230 to the secondary auditing system server 240. The network 260 may be a global network, such as the Internet or other publicly accessible network. Various elements of the network 260 may be interconnected by a wide area network, a local area network, an Intranet, and/or other private network, which may, or may not, be accessible by the general public.

Thus, the network 260 may represent a combination of public and private networks or a virtual private network (VPN). The network 260 may be a wireless network, a wireline network, or may be a combination of both wireless and wireline networks.

Although the primary auditing system server 220, remote connection system server 230, and the secondary auditing system server 240 are shown as separate physical servers, it will be understood that the functionality and capabilities of the various servers maybe logically combined/divided among one or more than one physical server.

Although FIG. 2 illustrates an example communication network 200 including a hierarchical auditing system for generating recommendations for health care service claims, it will be understood that embodiments of the present disclosure are not limited to such configurations, but are intended to encompass any configuration capable of carrying out the operations described herein.

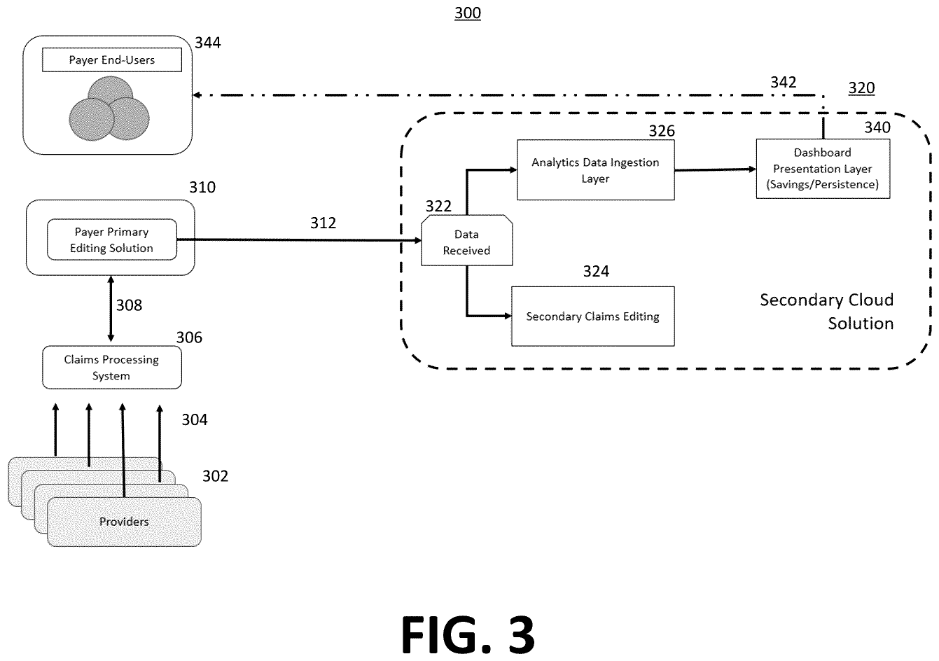

FIG. 3 is a block diagram that illustrates a system 300 for processing claims to present data via a dashboard user interface. Providers 302 can send claims 304 to the payor's claims processing system 306. It should be understood that the providers 302, claims 304, and claims processing system 306 can represent any number of providers, 302, claims 304, and claims processing systems 306. For example, the system in some embodiments can include any number of providers 302, and each of the providers 306 can have more than one claims processing system 306.

The claims 308 processed by the claims processing system 306 can be transmitted to the payor primary editing system 310. The primary editing system 310 may include a ClaimsXten® payment solution (CXT). The primary editing module 310 can be configured with editing rules that have been licensed, approved, and activated. The claims 312 edited by the primary editing solution 312 can be transmitted to the input 322 of a secondary editing system 320 that can be part of the system 300.

The input 322 to the secondary claims editing system 320 can transmit the claims to a secondary editing system 324. The secondary claims editing system 324 can include a secondary instance of a primary editing system 310. that can be configured with rules that have not been set up on the primary instance (i.e., using different rules from those used by the primary editing system 310). In an example where the primary editing system 310 is CXT, the secondary claims editing system 324 can be a second instance of CXT, that can optionally be set up with different/additional rules as compared to the primary editing system 310 that includes CXT. The secondary claims editing system 324 can perform the same operations as the primary claims editing system 310, but, as described herein, can be configured to use different rules from the primary claims editing system 310.

The input 322 may also transmit the claims 312 processed by the primary editing system 310 into an Analytics Data Store (ADS) 326. Once input to the ADS 326, the data can be processed by the ADS 326 to produce results available for display via a Saving and Persistence Dashboard module 340.

It should be understood that the primary editing system 310 and secondary claims editing system 320 can be configured to use the same types of files and file formats. However, it should also be understood that the primary 310 and secondary 320 claims editing systems can operate independently and using different rules. For example, the primary claims editing system 310 can be implemented using one computer or server, and the secondary claims editing system 320 can be implemented using a different computer or server. In other instances, they may both be implemented on the same computer or server.

The output 342 from the saving and persistence dashboard module 340 can be transmitted to one or more users for display and viewing by one or more end user 344.

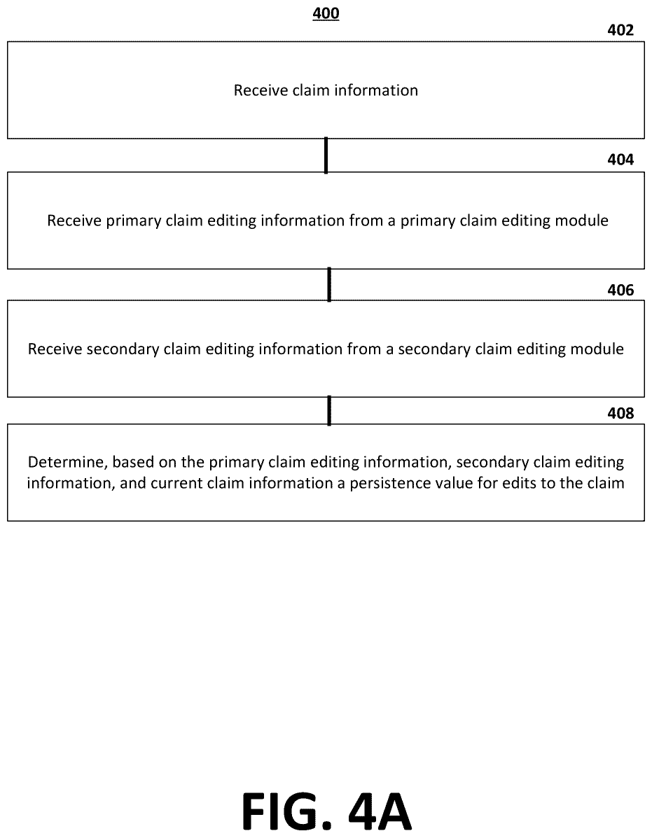

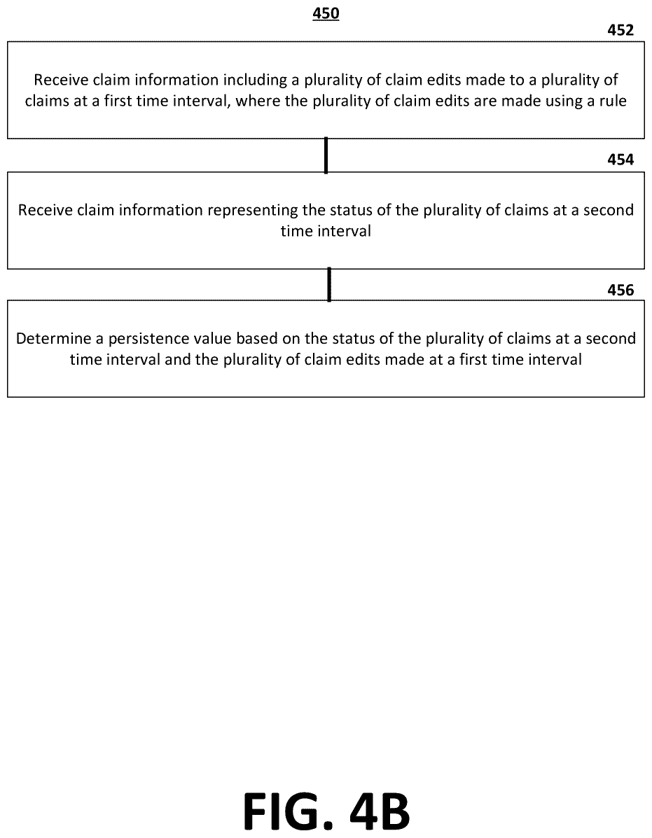

FIG. 4A illustrates an example method that can be used by the Savings and Persistence module 340 to generate the output 342 to display to the one or more payor end users 344. The method 400 illustrated in FIG. 4A can determine persistence by tracking claim versions across time. Embodiments of the present disclosure can be configured to track claim versions across different claim processing systems, even if those claim processing systems encode claim versions in different ways.

At step 402, information about the current status of the claim can be received by the analytics data store (e.g., the analytics data store 326 shown in FIG. 3). The information about the current status of the claim can be provided by the one or more of the primary claim editing system and the secondary claim editing system. The information about the current status of the claim can include information about the amount of money paid on the claim, and which parts of the claim were paid.

At step 404, primary claim editing information can be received by the analytics data store. The primary claim editing information can be transmitted to the analytics data store by the primary claim editing system (e.g., the primary claim editing system 310 shown in FIG. 3). The primary claim editing information can include information that represents an original version of a claim that was received by the primary editing module (e.g., the primary editing system 310 shown in FIG. 3), as well as information representing the edits performed on the claim by the primary editing module.

At step 406, secondary claim editing information can be received by the analytics data store from a secondary claim editing system (e.g., the secondary claims editing system 324 shown in FIG. 3). The secondary claim editing information can include information representing the original version of the claim that was received by the secondary claim editing system, as well as the edits performed by the secondary claim editing system.

At step 408, a persistence value can be determined by the saving and persistence dashboard module (e.g., the savings and persistence dashboard module 340 shown in FIG. 3). In the present disclosure, “savings” refers to an amount of money that the payor would have had to pay, but for the claim edits that were made. In the present disclosure, “persistence” refers to whether a claim edit made according to a rule is still present at a later point in time. Information about persistence of different types of claim edits can be useful because claim edits can be removed from claims over time. For example, a claim edit can be determined to have been in error by a payor, payee, or other person associated with the claim, and removed from the claim. A payor can monitor claim edit persistence over time to assess the impact of a rule. As used herein “persistence value” refers to the fraction of the original edits or the fraction of the savings associated with those edits that are still present at a later point in time. As described further with respect to the examples below, the persistence value can be determined by measuring the number of edits and/or savings associated with those edits during a first time interval, and then measuring the number of edits and/or savings associated with those edits at a later point in time. The persistence value can be the fraction of the savings or number of edits that are still present at the later point in time. The present disclosure contemplates that the time interval can be any amount of time, and some non-limiting examples of time intervals are one day, one week, and one month.

In the example method illustrated in FIG. 4A, the savings and persistence dashboard module can determine the persistence value based on the primary claim editing information, secondary claim editing information, and the current status of the claim.

Additionally, while the method described in FIG. 4A is described with reference to a primary and secondary claim editing system, it should be understood that, in some embodiments of the present disclosure, the persistence value can be determined using only a single claim editing system. FIG. 4B illustrates a method 450 for determining a persistence value based on claim information at a first time interval and claim information at a later point in time. The method 450 can include receiving 452 claim information including a plurality of claim edits made to a plurality of claims at a first time interval, where the plurality of claim edits are made using a rule. The method can further include receiving 454 claim information representing the status of the plurality of claims at a second time interval. The method can further include determining 456, based on the claim information received at steps 452 and 454, a persistence value of the claim edits made at the first time interval.

The persistence value for the claim can represent the percentage of the savings from a claim edit that persist over time. The savings can be measured as a dollar amount of savings, for example by subtracting the price of an edited claim line from the original price of the claim line. Alternatively, the savings can be measured as a percentage of the number of claims or claim lines that persist over time. For example, if a rule is applied to a set of claims, and results in edits to certain claim lines, then the percentage of those edits that persist over time can represent a persistence value for those edits.

In other words, if a rule is applied to 100 claims at a first point in time (e.g., in a month), then some of those applications of the rule will likely be overturned over time for various reasons (e.g., because the rule was applied erroneously). So at a second point in time (e.g., when the report is run) the rule that was originally applied to 100 claims at the first point in time may be applied to less than the 100 claims. Let's say that at the second point of time the rule that was originally applied to 100 claims is then (at the second point in time) only applied to 78 of the claims. The fraction of the claims that the rule remains applied to at the second point in time is the fraction of the claim edits that “persisted” from the first point in time to the second point in time. In this example, the persistence value is 0.78, or 78 percent.

In some embodiments of the present disclosure, the persistence value can be determined for a specific rule that can be applied by the system. When a rule is applied to a claim to deny part or all of the claim, it can be referred to herein as “triggering” the rule, or as an “instance” of a rule being applied. The system can aggregate all the individual instances where a rule was triggered during a time period. Non-limiting examples of time periods that can be used include a day, a week, and a month. The claims during this time period can represent the “baseline.” At a later point in time, the system can measure the persistence of the claim edits made during the time period by checking whether the edits based on the rule are still part of the claim at the later point in time. The edits that are still part of the claim can be considered to have persisted. Then, a persistence value can be determined based on the state of the claims during the first time period and during the later point in time. For example, the persistence value can represent the percentage of the claims where the edit is still part of the claim at the later point in time. Alternatively, the persistence value can be determined by taking the value of the claim edits during the first time period, and comparing it to the value of the claim edits that are still part of the claims at the later point in time, so that the percentage value represents the percentage of the savings that “persisted” through the later point in time.

As a non-limiting example of persistence determinations, in some embodiments of the present disclosure, the persistence value can be determined based on the savings from applying a rule, so that the persistence value represents how much of the savings from applying that rule are eventually realized by applying that rule. The system can track each instance where a rule was applied to a claim during a one-month time interval, and count how many times the rule was applied, and the monetary value of the savings associated with the applications of that rule. The rule can be applied any number of times to any number of claims, so that a rule might be applied hundreds of thousands of times to affect hundreds of thousands of claims. When the system determines the persistence of the edits at a later point in time, the system can check the claims that the rule was applied to originally again. The system can count how many of the edits based on the rule were overturned or revised, and what the value of the overturned/revised edits was. Then, the system can count how many edits remain on the originally edited claims, and what the savings associated with those edits are. Then, the system can determine the persistence value by comparing the number of edits at the later point in time to the number of original edits, and/or by comparing the savings at the later point in time to the original savings.

In some embodiments of the present disclosure, the method illustrated in FIG. 4A can be performed using a single claim editing solution. Alternatively, or additionally, methods of determining persistence of claim edits can be used with any number of claim editing systems (e.g., primary editing, secondary editing, tertiary editing, etc).

As another example of what “persistence” means, in the present disclosure, a claim edit made during the primary or secondary editing processes, but later reverted, would not be a “persistent” edit, whereas a claim edit made during the primary and secondary editing processes, but which resulted in savings to the payor on the later bill, would count as a persistent edit.

Embodiments of the present disclosure can use different methods to determine how claims are related to each other, and to determine the persistence value for a claim. In some claim processing systems, a new version of a claim can have the same claim ID as the old version of the claim, and the new and old versions can be distinguished via a transaction timestamp. Alternatively, or additionally, in some claim processing systems, the claim IDs need not match, but new versions will link themselves to their prior versions using a tag, which can be referred to as “prior claim ID”. When claims are linked to their prior versions, a hierarchal data structure can be created that can include any number of levels to store the relationship between each version of a set of related claims. It should be understood that these example systems for tracking claim versions are intended only as non-limiting examples.

Determining the persistence value of the claim can include performing persistence calculations. As a non-limiting example, a persistence calculation can identify the “baseline” (i.e., original) version of a claim, and the most recently available version, where the most recently available version can be different from the original. The method can also include aggregating the savings across the original and most recently available versions of the claim, and determining the savings of the revised claim.

There can be cases where a certain rule (“Rule A”) is triggered on the baseline version of a claim, and due to revision and resubmission a different rule (“Rule B”) is triggered on a later version of that claim. In other words, Rule B is redundant to Rule A, so Rule B does not generate any additional savings. In situations like the example with Rule A and Rule B, there would be no baseline savings for Rule B on those claims, making the fraction (revised/baseline) undefined. Embodiments of the present disclosure can include or exclude redundant claim edits from the methods of determining the persistence of those claim edits.

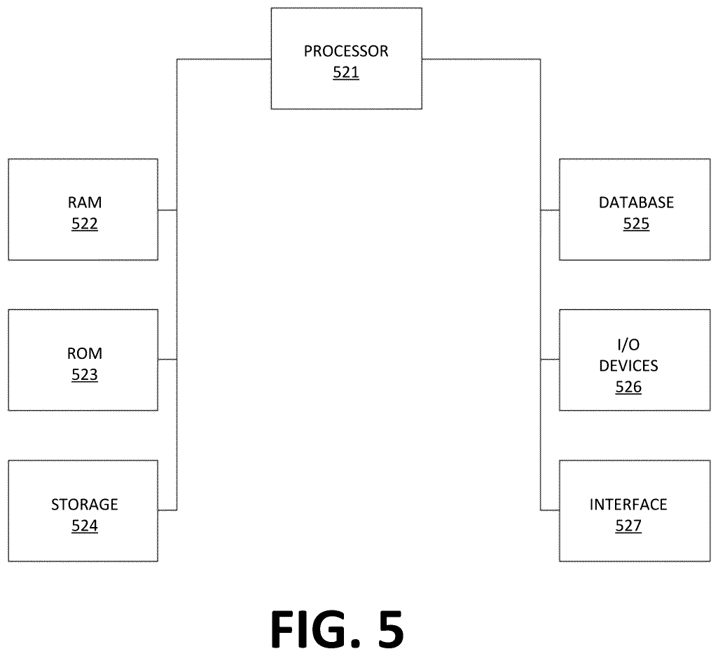

FIG. 5 illustrates an exemplary computer that can be used for implementing embodiments of the present disclosure, including systems for performing primary claims editing, secondary claims editing, determining the persistence of claim edits, and/or displaying those claims edits to users. As used herein, “computer” may include a plurality of computers. The computers may include one or more hardware components such as, for example, a processor 521, a random access memory (RAM) module 522, a read-only memory (ROM) module 523, a storage 524, a database 525, one or more input/output (I/O) devices 526, and an interface 527. Alternatively and/or additionally, the computer may include one or more software components such as, for example, a computer-readable medium including computer executable instructions for performing a method associated with the exemplary embodiments. It is contemplated that one or more of the hardware components listed above may be implemented using software. For example, storage 524 may include a software partition associated with one or more other hardware components. It is understood that the components listed above are exemplary only and not intended to be limiting.

Processor 521 may include one or more processors, each configured to execute instructions and process data to perform one or more functions associated with a computer for systems and methods of performing primary claims editing, secondary claims editing, determining the persistence of claim edits, and/or displaying those claims edits to users. Processor 521 may be communicatively coupled to RAM 522, ROM 523, storage 524, database 525, I/O devices 526, and interface 527. Processor 521 may be configured to execute sequences of computer program instructions to perform various processes. The computer program instructions may be loaded into RAM 522 for execution by processor 521.

RAM 522 and ROM 523 may each include one or more devices for storing information associated with operation of processor 521. For example, ROM 523 may include a memory device configured to access and store information associated with the computer, including information for identifying, initializing, and monitoring the operation of one or more components and subsystems. RAM 522 may include a memory device for storing data associated with one or more operations of processor 521. For example, ROM 523 may load instructions into RAM 522 for execution by processor 521.

Storage 524 may include any type of mass storage device configured to store information that processor 521 may need to perform processes consistent with the disclosed embodiments. For example, storage 524 may include one or more magnetic and/or optical disk devices, such as hard drives, CD-ROMs, DVD-ROMs, or any other type of mass media device.

Database 525 may include one or more software and/or hardware components that cooperate to store, organize, sort, filter, and/or arrange data used by the computer and/or processor 521. For example, database 525 may store information about the claims and/or the persistence information about the claims. It is contemplated that database 525 may store additional and/or different information than that listed above.

I/O devices 526 may include one or more components configured to communicate information with a user associated with computer. For example, I/O devices may include a console with an integrated keyboard and mouse to allow a user to maintain a database of digital images, results of the analysis of the digital images, metrics, and the like. I/O devices 526 may also include a display including a graphical user interface (GUI) for outputting information on a monitor. I/O devices 526 may also include peripheral devices such as, for example, a printer for printing information associated with the computer, a user-accessible disk drive (e.g., a USB port, a floppy, CD-ROM, or DVD-ROM drive, etc.) to allow a user to input data stored on a portable media device, a microphone, a speaker system, or any other suitable type of interface device.

Interface 527 may include one or more components configured to transmit and receive data via a communication network, such as the Internet, a local area network, a workstation peer-to-peer network, a direct link network, a wireless network, or any other suitable communication platform. For example, interface 527 may include one or more modulators, demodulators, multiplexers, demultiplexers, network communication devices, wireless devices, antennas, modems, and any other type of device configured to enable data communication via a communication network.

### EXPERIMENTS/EXAMPLES

The following examples are set forth below to illustrate the methods and results according to the disclosed subject matter. These examples are not intended to be inclusive of all aspects of the subject matter disclosed herein, but rather to illustrate representative methods and results. These examples are not intended to exclude equivalents and variations of the present disclosure which are apparent to one skilled in the art.

Efforts have been made to ensure accuracy with respect to numbers (e.g., amounts, ranges, temperature, etc.) but some errors and deviations should be accounted for.

### Example 1: Primary and Secondary Editing Use Case

A non-limiting example describing the uses of primary and secondary editing is described herein. A member (i.e., a patient corresponding to a particular payor) is scheduled to have an ACL repair on his/her knee on January 15^{th} at Paoli Hospital Outpatient center. The member has an EKG and pre-op blood work done prior to his/her surgery on January 7^{th} also at the Paoli Outpatient Hospital Center.

The example payor has an example policy. In the example policy, all the fees for the surgery are bundled and included in the Facility fee for the surgery. In the example policy, any pre-op testing done is included in the global fee for the surgery.

The claim for the pre-op testing is submitted by Paoli Hospital to the payor on January 8^{th}. The example claim includes the following example information:
Claim 1234
Member Sally Jones DOS 1/7/2022 Provider Paoli Outpatient Center
Line 1 93010 (EKG) billed units 4 billed amount $400
Line 2 80053 (lab test) billed units 4 billed amount $800

The primary editor can evaluate this claim and apply primary edits. In the example, primary edits are typically clinically sourced, industry standard edits that can be found in a public domain file. An example of a primary edit is the medically unlikely edits (MUE) from CMS (i.e., the Centers for Medicare and Medicaid Services). This edit puts a limit on the number of services allowed on a procedure code in one day.

Based on the example claim lines 1 and 2, the following claim result can be output by the primary editor:
Line 1 93010 (EKG) billed units 4 billed/pay amount $400 DENY this LINE (only 1 EKG is allowed per day per the MUE guideline from CMS)
Line 2 80053 (lab test) billed units 4 billed/pay amount $800 DENY this LINE (only 1 lab test 80053 is allowed per the MUE guideline from CMS)
Line 3 93010 (EKG) billed units 1 billed/pay amount $100 ADD this LINE to the claim (one test can be allowed and recommended for payment)
Line 4 80053 (lab test) billed units 1 billed/pay amount $200 ADD this LINE to the claim (one test can be allowed and recommended for payment)
The claim can be sent to the secondary editor on January 8^{th} and, in the example, no secondary edits are applied. In this example, the system is configured so that the secondary edits are payment policy type of editing, and not industry standard public domain file edits.
Still with reference to the same non-limiting example, the claim for the ACL repair can be submitted by Paoli Hospital on January 15^{th}
Claim 5678
Member Sally Jones DOS 1/15/2022 Provider Paoli Outpatient Center
Line 1 29888 (ACL Repair)

The primary editor can evaluate this claim and apply primary edits. In the example, this can be a claim with no primary edits apply to this claim.

Claim 5678 can be evaluated in the secondary editor which is typically used to apply payment policy type of rules. This claim meets the criteria for a rule in the secondary editor that identifies surgical procedures that are paid globally and include the payment for pre-op testing.

Now Claim 1234 can be pulled back into the unit of work for editing in the secondary editor and this time when this claim processes both claim lines on claim 1234 are denied because, in the example, the payment for the pre-op tests is included in the payment for the ACL Repair (claim 5678).
Line 3 93010 (EKG) billed units 1 billed/pay amount $100 DENY this claim line do not pay
Line 4 80053 (lab test) billed units 1 billed/pay amount $200 DENY this claim line do not pay

### Example 2: Persistence Reporting

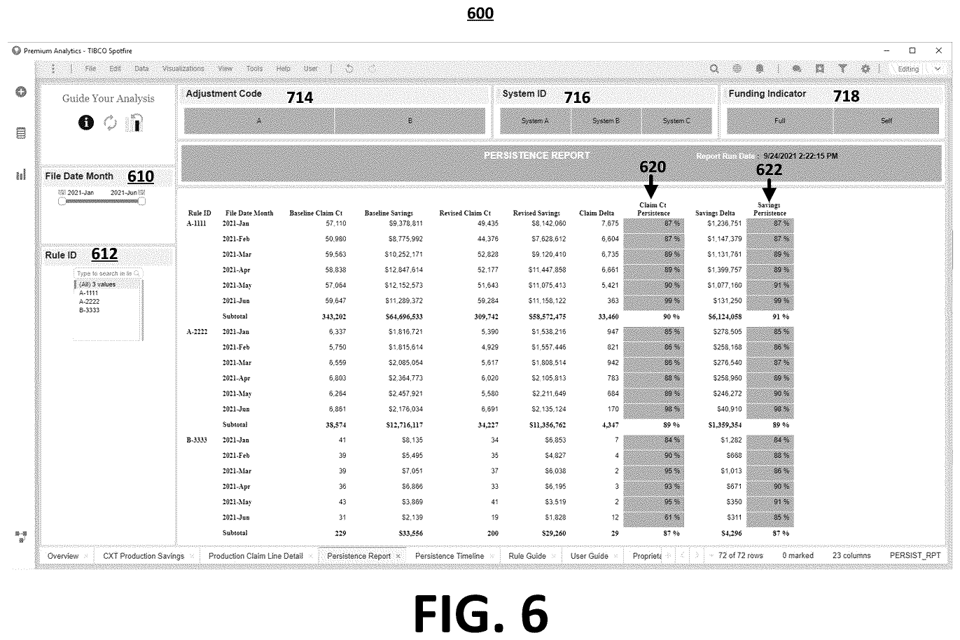

As described herein with reference to FIGS. 3, 4A and 4B, embodiments of the present disclosure include systems and methods that can be used to determine the persistence of claim edits and perform persistence reporting. A non-limiting example of a persistence report 600 is illustrated in FIG. 6. When editing rules are triggered on a claim line, they usually generate savings. In many situations, the claim line can be denied altogether; in other situations, the line can be recommended for reduced payment. Over time, a provider may alter and then resubmit a claim that has been denied or reduced. Through this resubmission process, savings that were initially recorded by a claims editing system can be undone. In this example, savings from rule edits are considered to “persist” over time when they are not undone by the revisions and resubmissions of providers. Payors can use persistence information (e.g., the report 600 illustrated in FIG. 6) to understand the persistence of the edits made by the payors. For example, persistence information can show that persistence can vary significantly from one type of rule to another.

The example user interface 600 for displaying a persistence report includes calculated persistence for each rule type across time, as well as across other dimensions of interest to the payor, such as line of business and processing system. The user interface 600 can display persistence values for any number of different rules, and can also display the persistence values for claim edits made in certain months. As described above, the persistence value can represent the persistence of a claim edit (i.e, the percentage of the original edits that remain at a later point in time) or the persistence of savings (i.e., the percentage of the original savings associated with the original claim edit that are still savings at the later point in time). The persistence report shown in FIG. 6 includes a column 620 showing the persistence of a rule applied to a claim, and a column 622 showing the persistence of savings applied to a claim.

The user interface 600 shown in FIG. 6 can optionally include one or more filters to configure how the persistence value is determined and displayed to the user by the user interface 600. In the non-limiting example shown in FIG. 6, the interface includes a date filter 610 that configures what range of dates are shown in the user interface 600. The user interface 600 also can include a rule id filter 612 that can be used to select what persistence values will be displayed. For example, a user can select any combination of adjustment code filter 614, system ID filter 616, and funding indicator filter 618 to show a persistence report for only certain instances where the rule was applied (e.g., only applications of the rule where a certain type of funding was used).

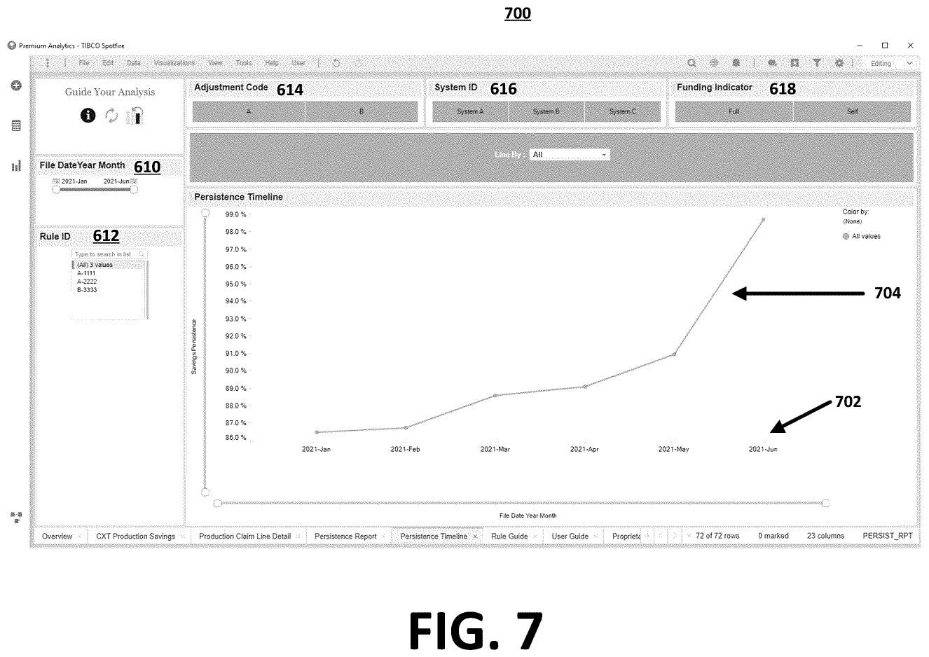

Additionally, the persistence report (e.g., the information shown in FIG. 6) can represented output a graph to a user interface. FIG. 7 illustrates an example user interface 700 including a timeline 702 with a persistence curve 704. The persistence curve 704 can also be referred to as a “survival curve.” The persistence curve 704 can be displayed for any rule, and the persistence curve 704 can illustrate how initial edit savings corresponding to the application of the rule erode overtime. A persistence curve 704 can illustrate the persistence of claim edits made according to a particular rule over time. The persistence curve 704 can, for example, show the persistence of edits made by a rule, and/or the persistence of savings associated with claim edits made according to a particular rule. The timeline 702 can be configured so that the end point of the timeline (i.e. the most recent date) is when the report is run, or the present day. So the persistence curve 704 can represent the persistence of claim edits made in previous time intervals. In the example user interface 700 shown in FIG. 7, the time intervals are one-month time intervals, so that the persistence curve 704 represents the fraction of claim edits made in previous months that persisted through when the report was run.

Additionally, the user interface 700 can include filters that can configure the display of the persistence curve 704. The filters in the user interface 700 can be any or all of the filters described with reference the user interface 600 for the persistence report shown in FIG. 6. In some use cases, a particular rule is most likely to cause the claim to be resubmitted within the first few months of initial adjudication, so that is the time period when the erosion of savings is most likely. The persistence curve 704 can be steepest in these first few months, which are the most recent months of the timeline 702. As the claim ages, the likelihood of resubmission goes down. So, by the time the claim is a year old, the probability of resubmission can be low, and the savings from applying the rule that have persisted up to that point are unlikely to erode further. In the example shown, the persistence curve 704 can be close to flat for a rule after a number of months have passed since the rule was applied (i.e., the less recent dates on the timeline 702).

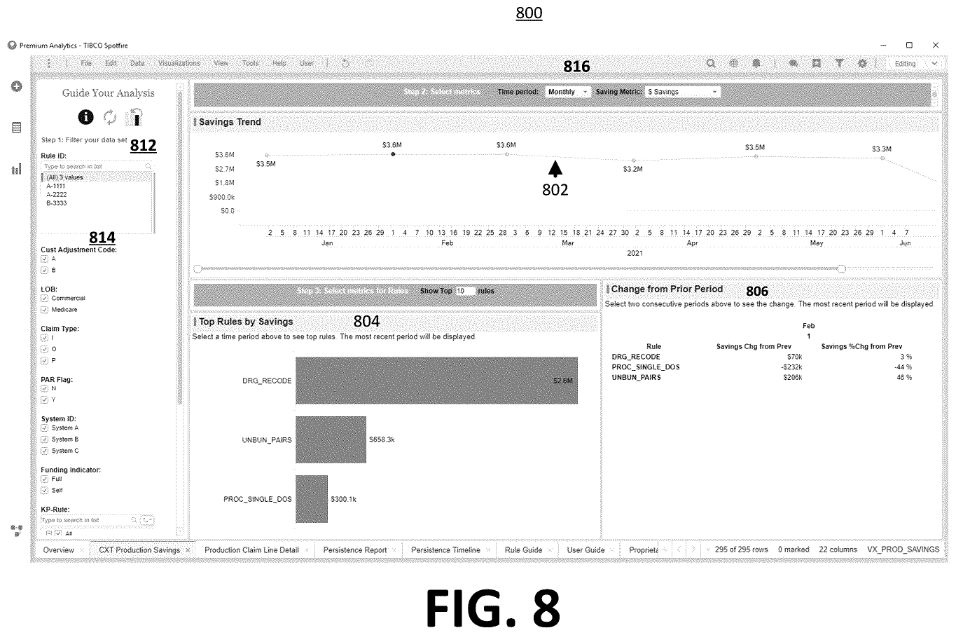

Another example interface 800 is shown in FIG. 8. The example interface 800 shows aggregated information about the savings trend 802, top rules by savings 804, and savings over time 806. The example interface 800 shown in FIG. 8 can be part of the output 342 of the system 300 shown in FIG. 3, and can include the persistence value determined using the method 400 illustrated and described with respect to FIG. 4A. Like the interface 700 shown in FIG. 7, the interface 800 can also include options to filter and sort the data displayed. The user can filter the data to specific rule IDs using a rule filter 812. The user can further filter the data using checkboxes 814. The length of time displayed for the savings trend 802 can be adjusted using a time period interface 816.

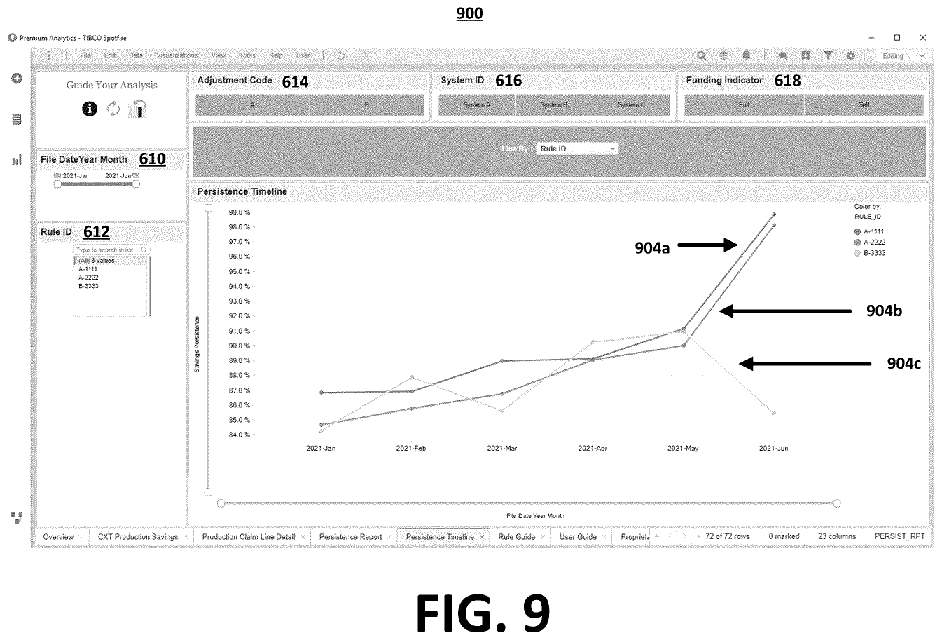

Yet another example interface 900 is shown in FIG. 9. The example interface 900 can include the persistence timeline 702 described with respect to FIG. 7. In FIG. 9, each the persistence curves 904a 904b 904c for each rule over time is illustrated separately. As shown in FIG. 9, a user can see from the interface 900 that the rule illustrated by curve 904c has lower persistence than the curves 904a 904b representing the other rules. The example interface 900 in FIG. 9 can include date filters 610, rule id filters 612, adjustment code filters 614, system id filters 616, and funding indicator filters 618, that are described with reference to FIGS. 6 and 7.

It should be understood that the example interfaces 600, 700, 800, 900 described with reference to FIGS. 6-9 are intended only as non-limiting examples, and that the present disclosure contemplates that other user interfaces can be used, including other user interfaces including different information or different combinations of information.

### CONCLUSION

It will be understood that each step of a method, block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. One example of such a computer is shown and described herein in relation to FIG. 5.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high-level procedural or object-oriented programming language to communicate with a computer system. However, the program(s) can be implemented in assembly or machine language, if desired. In any case, the language may be a compiled or interpreted language and it may be combined with hardware implementations.

While this specification contains many specific implementation details, these should not be construed as limitations on the claims. Certain features that are described in this specification in the context of separate implementations may also be implemented in combination in a single implementation. Conversely, various features that are described in the context of a single implementation may also be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

It should be appreciated that the logical operations described herein with respect to the various figures may be implemented (1) as a sequence of computer implemented acts or program modules (i.e., software) running on a computing device, (2) as interconnected machine logic circuits or circuit modules (i.e., hardware) within the computing device and/or (3) a combination of software and hardware of the computing device. Thus, the logical operations discussed herein are not limited to any specific combination of hardware and software. The implementation is a matter of choice dependent on the performance and other requirements of the computing device. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method comprising:
receiving claim edit information comprising a plurality of claim edits made to a plurality of claims at a first time interval, wherein the plurality of claim edits are made using a rule;
receiving claim information representing the status of the plurality of claims at a second time interval; and
determining a persistence value based on the plurality of claims at a second time interval and the plurality of claim edits made at a first time interval.

2. The method of claim 1, wherein the persistence value comprises information about the value of the claims at the first time interval and the second time interval.

3. The method of claim 1, wherein the persistence value comprises information about a number of edits to the claims at the first time interval and at the second time interval.

4. The method of claim 1, wherein the first time interval is one month.

5. The method of claim 1, further comprising displaying a user interface comprising a visualization of the persistence value.

6. The method of claim 5, wherein the visualization of the persistence value comprises a survival curve.

7. The method of claim 1, wherein the plurality of claim edits are made using a primary editing system and a secondary editing system.

8. A system comprising:
a memory device having instructions stored thereon that, when executed by one or more processors, cause the one or more processors to perform operations comprising:
receiving claim information comprising a claim and an amount paid on the claim;
receiving primary claim editing information from a primary claim editing system comprising a primary edit made to the claim, wherein the primary edit comprises a decision to deny a first portion of the claim;
receiving secondary claim editing information from a secondary claim editing system comprising a secondary edit made to the claim, wherein the secondary edit comprises a decision to deny a second portion of the claim; and
determining, based on the claim information, the primary claim editing information, and the secondary claim editing information, a persistence value for the claim.

9. The system of claim 8, wherein the persistence value comprises information about the value of the claim.

10. The system of claim 8, wherein the claim information comprises information about whether the primary and secondary edits were denied.

11. The system of claim 8, wherein the persistence value comprises information about whether the primary edit and the secondary edit caused a savings on the final amount paid on the claim.

12. The system of claim 8, further comprising displaying a user interface comprising a visualization of the persistence value.

13. The system of claim 12, wherein the visualization of the persistence value comprises a survival curve.

14. The system of claim 8, wherein the primary edits or secondary edits comprise a plurality of rules, and wherein the visualization of the persistence value comprises a survival curve for each of the rules.

15. A non-transitory computer readable media having instructions stored thereon that, when executed by one or more processors, cause the one or more process to perform operations comprising:
receiving claim information comprising a claim and an amount paid on the claim;
receiving primary claim editing information from a primary claim editing system comprising a primary edit made to the claim, wherein the primary edit comprises a decision to deny a first portion of the claim;
receiving secondary claim editing information from a secondary claim editing system comprising a secondary edit made to the claim, wherein the secondary edit comprises a decision to deny a second portion of the claim; and
determining, based on the claim information, the primary claim editing information, and the secondary claim editing information, a persistence value for the claim.

16. The computer readable media of claim 15, wherein the persistence value comprises information about the value of the claim.

17. The computer readable media of claim 15, wherein the claim information comprises information about whether the primary and secondary edits were denied.

18. The computer readable media of claim 15, wherein the persistence value comprises information about whether the primary edit and the secondary edit caused a savings on the final amount paid on the claim.

19. The computer readable media of claim 15, further comprising displaying a user interface comprising a visualization of the persistence value.

20. The computer readable media of claim 19, wherein the visualization of the persistence value comprises a survival curve.
